(19) United States
(12) Patent Application Publication
(10) Pub. No.: US 2009/0255156 A1
(43) Pub. Date: Oct. 15, 2009

(54) ILLUSIONARY LIGHT SOURCE DEVICE

(75) Inventors: Chia-chun Lai, Taipei City (TW); Regina-weiyao Wang, Taipei City (TW)

Correspondence Address: KIRTON AND MCCONKIE, 60 EAST SOUTH TEMPLE,, SUITE 1800, SALT LAKE CITY, UT, 84111, US

(73) Assignee: National Taiwan University of Science and Technology, Taipei City (TW)

(21) Appl. No.: 12/180,598

(22) Filed: Jul. 28, 2008

(30) Foreign Application Priority Data
Apr. 11, 2008 (TW) 097113186

(51) Int. Cl. G09F 13/08

(52) U.S. Cl. 40/442

(57) ABSTRACT

An illusionary light source device is disclosed. The illusionary light source device includes a light emitting unit and a picture layer. The picture layer can partially block and partially transmit the light from the light emitting unit. Blocking areas and transmitting areas of the picture layer can be properly arranged to form a picture. The picture is therefore presented by the transmitting light. The illusionary light source device further includes a partial-light-blocking layer. The partial-light-blocking layer also can partially block and partially transmit the light from the light emitting unit. The partial-light-blocking layer is disposed between the light emitting unit and the picture layer. Light is emitted through the partial-light-blocking layer and then presented on the picture layer. By the relative motion between any two of the light emitting unit, the partial-light-blocking layer and the picture layer, the picture layer presents a wonderful light show.

### TECHNICAL FIELD OF THE INVENTION

The present invention relates to a picture exhibition device, and more particularly, to a picture exhibition device with light projected.

### BACKGROUND OF THE INVENTION

Presently, decorative articles, advertising boards, and light sources for interior design usually generate various kinds of visual effects by altering the luminosity of a light source or the color of light. For example, an advertising board generates various kinds of light shows with a light source, such as a neon lamp or a light emitting diode (LED) lamp. Among those light shows, a dynamic shining effect is generated by alternately opening and closing the light source or by altering the luminosity of the light source with an electrical controller. In addition, for lighting designs on stages, the light source is also rotated for generating more abundant effects.

The dynamic shining effect is quite common for lighting designs, but the effect is still not subtle enough. On the other hand, the dynamic shining effect is too common to attract attention. Therefore, a novel exhibition will be needed.

### SUMMARY OF THE INVENTION

The present invention provides a design of picture presentation applicable to the fields of advertisement, art, and interior design, etc. The picture presentation of the present invention is capable of attracting spectator's attention and may exist potential economic benefits.

An aspect of the present invention is to provide an illusionary light source device. The illusionary light source device comprises a light emitting unit and a picture layer. The picture layer is positioned with respect to the light emitting unit for partially blocking and partially transmitting the light from the light emitting unit with blocking areas and transmitting areas respectively. The blocking areas and the transmitting areas of the picture layer are arranged to form a picture, and the picture is presented by the transmitting light so that the transmitting areas of the picture are made glory.

Another aspect of the present invention is that the illusionary light source device further comprises a partial-light-blocking layer. The partial-light-blocking layer is disposed between the light emitting unit and the picture layer, also comprising a distribution of transmitting areas for partially blocking and partially transmitting the light from the light emitting unit. Light is emitted through the partial-light-blocking layer and then presented on the picture layer so that the picture is made glory in response to the distribution of the transmitting areas of the partial-light-blocking layer. In addition, a relative motion between any two of the light emitting unit, the partial-light-blocking layer, and the picture layer is selectively made for presenting a light show on the picture layer. In addition, motion of occurring on or between the light emitting unit, the partial-light-blocking layer, or the picture layer is selected from a group of motions consisting of sliding, rotation, and vibration.

Another aspect of the present invention is that the picture layer of the illusionary light source device has a plurality of first transmitting apertures, and the partial-light-blocking layer of the illusionary light source device has a plurality of second transmitting apertures. Arrangement of the first transmitting apertures on the picture layer forms the picture. The light from the light emitting unit becomes dazzling because of a relative motion between the first and the second transmitting apertures, and the picture is presented by the dazzling light going through the first transmitting apertures.

The illusionary light source device of the present invention presents the picture with marvelous appearance, such as shining like a diamond or water flowing by a light source. The partial-light-blocking layer, partially blocking and partially transmitting the light from the light emitting unit, makes the light becoming illusionary or dazzling.

The illusionary light source device of the present invention can employ various kinds of light sources. In addition, the visual effect generated by the present invention is marvelous. The present invention can apply to products that need the visual effect in the fields of advertisement, decoration, and design, etc. Moreover, the present invention can apply to festoon lightings (lifting, hanging, suspending, putting, or standing types), interior designs (ceiling, floor, wall, bar, or hallway), advertising boards, landscape designs, lighting designs on stages, and objects (flat or solid ones).

### BRIEF DESCRIPTION OF THE DRAWINGS

FIG. 1 is a diagram illustrating an embodiment of picture presentation according to the present invention.

FIG. 2 is a diagram illustrating another embodiment of picture presentation according to the present invention.

FIG. 3 is an exemplary diagram showing a picture of a picture layer according to the present invention.

FIG. 4 is a structure diagram illustrating an illusionary light source device according to the present invention.

### DETAILED DESCRIPTION OF THE INVENTION

The present invention will be described in details in conjunction with the appending drawings.

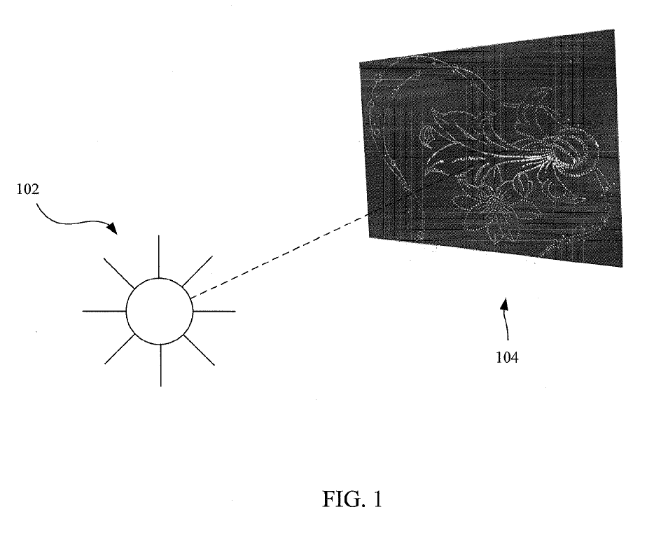

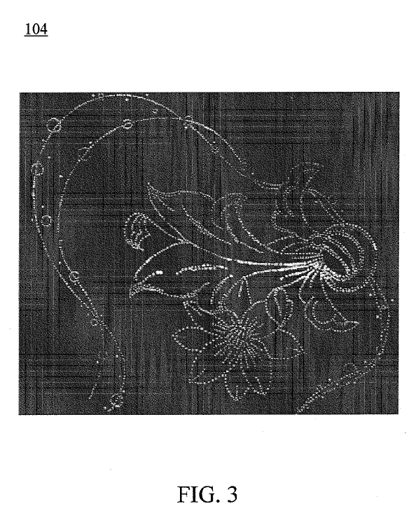

Referring to FIG. 1, which is a diagram illustrating an embodiment of picture presentation according to the present invention, a picture layer 104 has a plurality of transmitting apertures. The picture layer 104 as an example for explaining the present invention more clearly shown in FIG. 3, wherein white dots of the picture layer 104 represent the transmitting apertures, and black parts of the picture layer 104 represent blocking areas to block light going through. A picture can be designed into an amazing one or a pattern by properly arranging the blocking areas and transmitting apertures of the picture layer. In addition, a light emitting unit 102 emits light, which goes through the transmitting apertures of the picture layer 104, but the light from the light emitting unit 102 can not go through the blocking areas of the picture layer 104. Therefore, the picture of the picture layer is presented clearly by the light from the light emitting unit 102 so that the transmitting areas of the picture are made glory. In addition, the picture is presented with different appearance while altering the luminosity of the light emitting unit or the color of light.

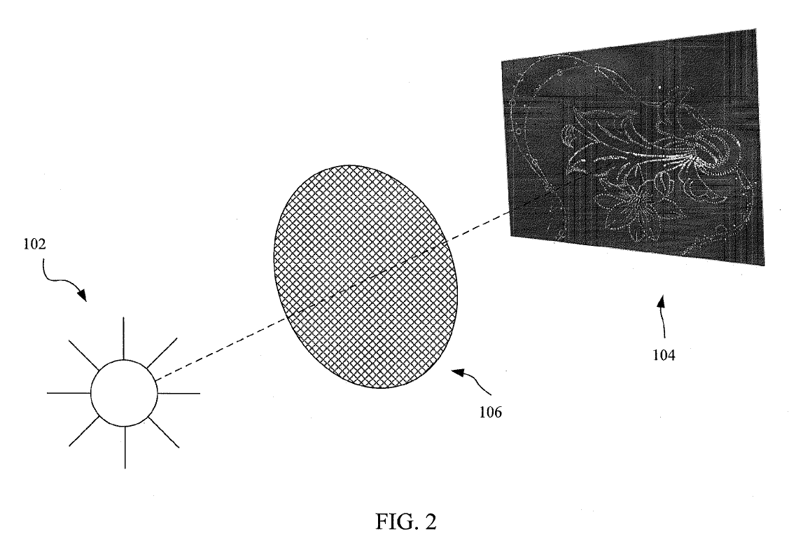

Referring to FIG. 2, which is a diagram illustrating another embodiment of picture presentation according to the present invention, in comparison to FIG. 1, said another embodiment of FIG. 2 further comprises a partial-light-blocking layer 106, which is disposed between the light emitting unit 102 and the picture layer 104. In addition, the partial-light-blocking layer 106 has a plurality of transmitting apertures arranged regularly (or, if desired, irregularly). Similarly, the light from the light emitting unit 102 can go through the transmitting apertures of the partial-light-blocking layer 106, but the light can not go through blocking areas of the partial-light-blocking layer 106. Moreover, a relative motion between any two of the light emitting unit 102, the partial-light-blocking layer 106, and the picture layer 104 makes the picture of the picture layer 104 presented with marvelous appearance, such as shining like a diamond or water flowing by a light source. Furthermore, concerning the relative motion between any two of the light emitting unit 102, the partial-light-blocking layer 106, and the picture layer 104, each one can be coupled to an electrical device for generating sliding, rotation, or vibration. For example, a motor can generate rotating motion of either one of the constituent components of the present invention.

Several exemplary situations for illustrating motions of the light emitting unit 102, the partial-light-blocking layer 106, or the picture layer 104 will be described in the following paragraphs.

One of the light emitting unit 102, the partial-light-blocking layer 106, and the picture layer 104 can be coupled to a motion generator for generating various types of motion, for example, a combination of sliding, rotation, and vibration. In addition, the motion type can be controlled by a mode controller; for example, the mode controller is employed to generate a random motion. Moreover, if the motion generator connects to the light emitting unit 102, this may result in an adjustable distribution of the light from the light emitting unit 102. If the motion generator connects to the partial-light-blocking layer 106, the transmitting apertures of the partial-light-blocking layer 106 move relative to the picture layer 104. This affects the presented picture indirectly. Furthermore, if the motion generator connects to the picture layer 104, the picture of the picture layer 104 is presented relative to a spectator dynamically, such as presentation on a rotating table.

Any one of the light emitting unit 102, the partial-light-blocking layer 106, and the picture layer 104 can be coupled to a scrolling device. For example, the partial-light-blocking layer 106 or the picture layer 104 can be designed in a long strip shape, and therefore, the partial-light-blocking layer 106 or the picture layer 104 can be scrolled by the scrolling device for generating relative motion. In other words, a relative sliding motion occurs between the partial-light-blocking layer 106 and the picture layer 104.

Any one of the light emitting unit 102, partial-light-blocking layer 106, and picture layer 104 can be coupled to an oscillator and oscillated (or reciprocally moved) by the oscillator. For example, the picture layer 104 is oscillated between two given points. In other words, a relative vibration is induced between the picture layer 104 and the partial-light-blocking layer 106 by the oscillator.

Any one of the light emitting unit 102, the partial-light-blocking layer 106, and the picture layer 104 can be coupled to a motor. For example, the partial-light-blocking layer 106 coupled to the motor rotates as a shaft of the motor rotates. Thus, a relative rotation between the partial-light-blocking layer 106 and the picture layer 104 is realized to generate an angular displacement therebetween.

In a situation that the light emitting unit 102, the partial-light-blocking layer 106, and the picture layer 104 are static or kept stationary, the transmitting apertures of the partial-light-blocking layer 106 can be arranged to form a specific pattern. In this situation, the light from the light emitting unit 102 projects onto the picture layer 104 through the specific pattern. Therefore, a distribution of glory areas of the picture is similar to a shape of the specific pattern.

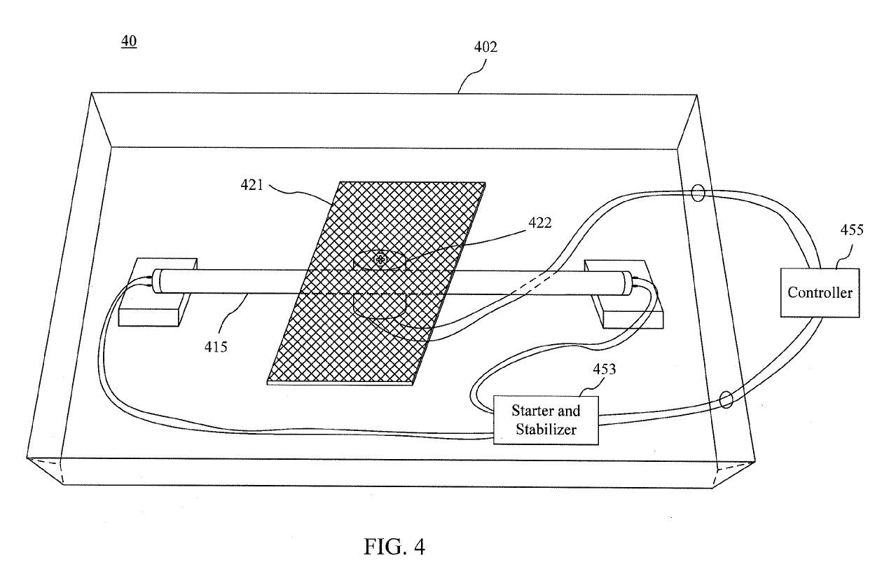

Further referring to FIG. 4, which is a structure diagram of an illusionary light source device 40 of the present invention, the illusionary light source device 40 comprises a box 402, a sunlight lamp 415, a partial-light-blocking layer 421, and a picture layer 104 (shown in FIG. 3). The sunlight lamp 415 is disposed inside the box 42. Other light sources can be employed as well. A motor 422 is disposed beside the sunlight lamp 415. The partial-light-blocking layer 421, fastened to a shaft of the motor 422, is disposed above the sunlight lamp 415. The partial-light-blocking layer 421 rotates as the shaft rotates owing to the power of the motor 422. In addition, the motor 422 and the sunlight lamp 415 are started up simultaneously or individually by a controller 455. The sunlight lamp 415 emits light after a starter and stabilizer 453 is enabled. Moreover, the picture layer 104 shown in FIG. 3 is disposed on the top of the box 402. The light from the sunlight lamp 415 goes through the partial-light-blocking layer 421 and then reaches the picture layer 104. Since the partial-light-blocking layer 421 is rotated, a relative motion occurs between the partial-light-blocking layer 421 and the picture layer 104. The light from the sunlight lamp 415 becomes dazzling because of the relative motion between the transmitting apertures of the partial-light-blocking layer 421 and the transmitting apertures of the picture layer 104. Therefore, a picture of the picture layer 104 is presented by the dazzling light going through the transmitting apertures of the picture layer 104. It is indeed a novel picture presentation, such as shining like a diamond or water flowing by a light source.

Furthermore, it is preferred that the transmitting apertures are distributed over the partial-light-blocking layer 421 equally, and the transmitting apertures of the picture layer 104 and the partial-light-blocking layer 421 are of the same size. In addition, numbers of the box 402 of the illusionary light source device 40 can be arranged to form a huge wall as a remarkable device of installation art. The box 402 of the illusionary light source device 40 also can be embedded into ceiling or floor board.

The above-mentioned light emitting unit 102 (or the sunlight lamp 415) can be employed as a light emitting diode (LED) lamp, an incandescent lamp, a sunlight lamp, a halogen lamp, or other light sources. In addition, the picture of the picture layer 104 can be presented with different appearance while altering the luminosity of the light emitting unit 102 (or the sunlight lamp 415) or the color of light.

The above-mentioned transmitting apertures of the partial-light-blocking layer 106 (or the partial-light-blocking layer 421) or picture layer 104 are not necessary to be circular. Other shapes, such as triangle, rectangle, and polygon, can be employed as well. In addition, the transmitting apertures of the partial-light-blocking layer 106 (or the partial-light-blocking layer 421) can be of the same size and distributed over the partial-light-blocking layer 106 (or the partial-light-blocking layer 421) regularly and equally, or alternatively, they also can be of different sizes and arranged irregularly into a specific pattern. Moreover, the picture of the picture layer 104 can be designed into a grading or modeling picture or word with different sizes and various shapes of the transmitting apertures.

The above-mentioned transmitting areas of the partial-light-blocking layer 106 (or the partial-light-blocking layer 421) or the picture layer 104 are not necessary to be apertures or hollow portions. Any material which is able to transmit light can be employed as the transmitting areas. In addition, the transmitting areas can be of different sizes and have various shapes. Moreover, the size of each transmitting area can be designed according to the distance between any two of the light emitting unit 102, the partial-light-blocking layer 106 (or the partial-light-blocking layer 421), and the picture layer 104.

While the preferred embodiments of the present invention have been illustrated and described in detail, various modifications and alterations can be made by persons skilled in this art. The embodiment of the present invention is therefore described in an illustrative but not restrictive sense. It is intended that the present invention should not be limited to the particular forms as illustrated, and that all modifications and alterations which maintain the spirit and realm of the present invention are within the scope as defined in the appended claims.

What is claimed is:

1. An illusionary light source device, comprising:
a light emitting unit; and
a picture layer, positioned with respect to the light emitting unit, for partially blocking and partially transmitting the light from the light emitting unit with a plurality of blocking areas and transmitting areas respectively, wherein the blocking areas and the transmitting areas of the picture layer are arranged to form a picture, and the picture is presented by the transmitting light so that the transmitting areas of the picture are made glory.

2. The illusionary light source device of claim 1, wherein the transmitting areas of the picture layer are a plurality of transmitting apertures, and an arrangement of the transmitting apertures on the picture layer forming the picture.

3. The illusionary light source device of claim 1, wherein the light emitting unit comprises a light source with variable luminosity, and the transmitting areas of the picture are made glory by altering the luminosity of the light emitting unit.

4. The illusionary light source device of claim 1, wherein the light emitting unit is selected from a group consisting of a light emitting diode (LED) lamp, an incandescent lamp, a sunlight lamp, and a halogen lamp.

5. The illusionary light source device of claim 1 further comprising a partial-light-blocking layer, which is disposed between the light emitting unit and the picture layer, also comprising a distribution of transmitting areas for partially blocking and partially transmitting the light from the light emitting unit, wherein light goes through the partial-light-blocking layer and then presents on the picture layer so that the picture is made glory in response to the distribution of transmitting areas of the partial-light-blocking layer.

6. The illusionary light source device of claim 5, wherein a relative motion between any two of the light emitting unit, the partial-light-blocking layer, and the picture layer is selectively made for presenting a light show on the picture layer.

7. The illusionary light source device of claim 6, wherein one of the light emitting unit, the partial-light-blocking layer, or the picture layer selectively undergoes a motion selected from a group consisting of sliding motion, rotation, and vibration.

8. The illusionary light source device of claim 6, wherein a relative motion is made between the partial-light-blocking layer and the picture layer.

9. The illusionary light source device of claim 8, wherein the picture layer has a plurality of first transmitting apertures, the partial-light-blocking layer has a plurality of second transmitting apertures, and an arrangement of the first transmitting apertures on the picture layer forms the picture, and wherein the light from the light emitting unit becomes dazzling because of a relative motion between the first and the second transmitting apertures, and the picture is presented by the dazzling light going through the first transmitting apertures.

10. The illusionary light source device of claim 9, wherein a shape of each first and each second transmitting apertures is of a specific geometrical shape.

11. The illusionary light source device of claim 9, wherein the second transmitting apertures are distributed over the partial-light-blocking layer equally, and each second transmitting aperture has the same size.

12. The illusionary light source device of claim 9, wherein the first and the second transmitting apertures are of the same size.

13. The illusionary light source device of claim 8, wherein the partial-light-blocking layer is coupled to a motor, the partial-light-blocking layer rotates as a shaft of the motor rotates, and a relative rotation between the partial-light-blocking layer and the picture layer is caused to generate an angular displacement.

14. The illusionary light source device of claim 8, wherein the relative motion between the partial-light-blocking layer and the picture layer is made by scrolling the partial-light-blocking layer, and thus a relative sliding motion occurs between the partial-light-blocking layer and the picture layer.

15. The illusionary light source device of claim 8, wherein the relative motion between the partial-light-blocking layer and the picture layer is made by scrolling the picture layer, and thus a relative sliding motion occurs between the partial-light-blocking layer and the picture layer.

16. The illusionary light source device of claim 8, wherein the partial-light-blocking layer is coupled to an oscillator and oscillated by the oscillator, and a relative vibration between the partial-light-blocking layer and the picture layer is caused to generate a displacement.

17. The illusionary light source device of claim 8, wherein the partial-light-blocking layer is coupled to a motion generator for generating a plurality of types of motion of the partial-light-blocking layer to made the relative motion between the partial-light-blocking layer and the picture layer.
